(19) United States
(12) Patent Application Publication
(10) Pub. No.: US 2013/0269014 A1
(43) Pub. Date: Oct. 10, 2013

(54) METHOD AND APPARATUS FOR BROWSER INTERFACE, ACCOUNT MANAGEMENT, AND PROFILE MANAGEMENT

(71) Applicant: Justin Brock GERBER, Anaheim, CA (US)

(72) Inventor: Justin Brock GERBER, Anaheim, CA (US)

(21) Appl. No.: 13/859,649

(22) Filed: Apr. 9, 2013

Related U.S. Application Data
(60) Provisional application No. 61/621,978, filed on Apr. 9, 2012.
(60) Provisional application No. 61/621,984, filed on Apr. 9, 2012.
(60) Provisional application No. 61/621,987, filed on Apr. 9, 2012.

(51) Int. Cl. G06F 17/22

(52) U.S. Cl. CPC G06F 17/2247; H04L 63/083
USPC 726/7; 715/234

(57) ABSTRACT

The present system provides a new interface for a user of the internet. The system presents a plurality of frequently visited sites to a user at a single location. When a site is visited by the user, a normalized version of the site is created for presentation to the user. The system allows the user to manage financial accounts from one location, with the user always logged into the user's accounts, and the consolidating and aggregating of information useful to the user. The system also allows for personalization and customization of a user profile.

This patent application claims priority to U.S. Provisional patent applications 61/621,978, 61/621,984, and 61/621,987 filed on Apr. 9, 2012, each of which is incorporated by reference herein in its entirety.

### BACKGROUND

The internet has become an important research, communication, and organizational tool for many users. However, the manner in which the internet is accessed and used has not kept pace with the needs of the users. With millions and millions of available sites, the internet is designed to visit one site at a time. In addition, although a user may transact on a plurality of sites, the current implementation does not provide intelligent linking and coordination of a user's actual use of the internet. Further, many people use the internet to assist in managing their financial affairs. However, to date the systems in place do not take full advantage of the capabilities of the internet. In addition, current approaches do not provide a truly personalized and customized experience for the user.

### SUMMARY

The present system provides a new interface for a user of the internet. The system presents a plurality of frequently visited sites to a user at a single location. The user can interact with a site in a number of new ways. In one embodiment, the system provides a list of categories of websites in a tool bar. These categories can include Social Media, Media, Finance, Web/News, Shopping, Connect, and Sharing. When the user initializes the system, the categories are unpopulated. As the user begins surfing the web as normal, the categories are populated with the websites that the user visits.

When a site is visited by the user, a normalized version of the site is created for presentation to the user. A plurality of these normalized versions can be resident on a single page in the form of tiles. The user may interact with the site at the reduced size, or may cause any individual site to expand to a larger presentation. In one embodiment, the expanded presentation is the actual version of the site instead of the normalized version.

The user can expand and contract these site tiles while still being resident on a personalized user page. An advantage of the system is that the user can log into the user's resident page on any computer that is connected to the internet, so that the user always has the system available.

In another embodiment, the present system provides a method and apparatus for managing accounts of a user, whether financial or other, and allows the user to manage financial accounts from one location, with the user always logged into the user's accounts, and the consolidating and aggregating of information useful to the user.

In another embodiment, the present system provides a method and apparatus for building and dynamically adapting a user profile in a browser environment. The system also provides a method presenting sites to a user in a meaningful order, and provides a system of sharing data between sites to improve and enhance the user experience.

### BRIEF DESCRIPTION OF THE DRAWINGS

FIG. 1 is an example of the categories in one embodiment of the system.

FIG. 2 illustrates the presentation of the Social Media category 101 in the drop down embodiment.

FIG. 3 is an example of an embodiment of the activated Media 102 category.

FIG. 4 is an embodiment of the display of the activated Finance category 103.

FIG. 5 illustrates an example of the Web.News category 104.

FIG. 6 is an embodiment of an activated Shopping category 105.

FIG. 7 illustrates an example of the system when the Connect category 106 is activated.

FIG. 8 is a flow diagram illustrating the operation of the system in an embodiment.

FIG. 9 is a flow diagram of the creation of a normalized presentation of a new website in an embodiment of the system.

FIG. 10 is a flow diagram illustrating an embodiment of initial setup of the system.

FIG. 11 is a flow diagram illustrating an embodiment of operation of the system.

FIG. 12 is a flow diagram illustrating scoring in an embodiment of the system.

FIG. 13 is a flow diagram illustrating profile generating in an embodiment of the system.

FIG. 14 is a flow diagram illustrating user profile updating in an embodiment of the system.

FIG. 15 is an example computer embodiment of the system.

### DETAILED DESCRIPTION OF THE SYSTEM

The system provides a manner of identifying and presenting frequent web sites to a user to improve the ability to use the internet. A user's frequent web sites are always available, not just through a “favorites” bookmark list, but by actually having “live” versions of multiple sites on a resident page. The system automatically adds sites to a user's categories as encountered.

Initialization

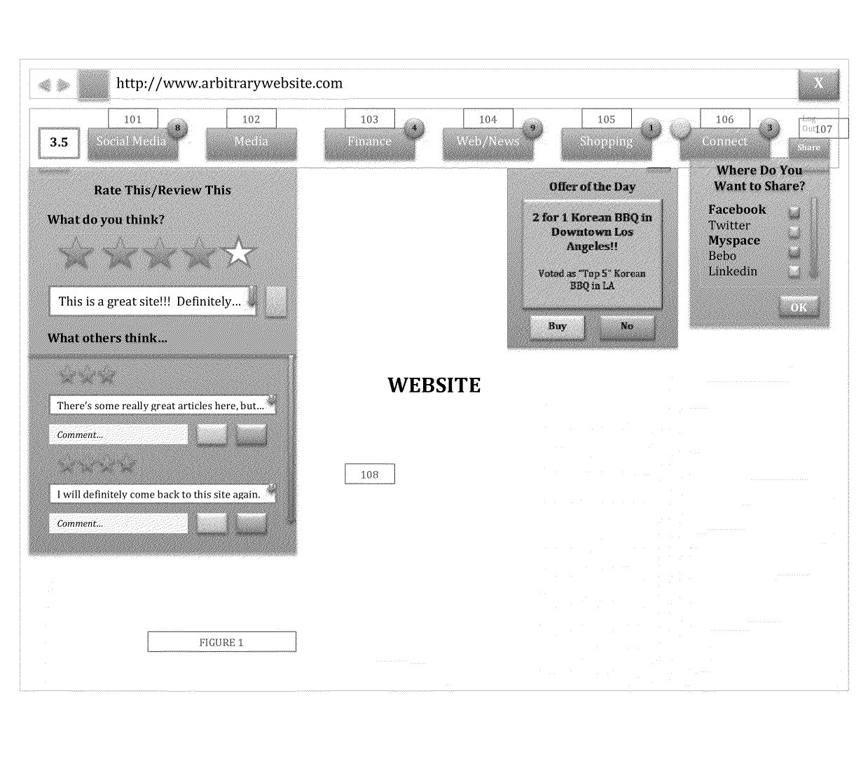

When a user initiates the system, a resident page is created with a tool bar that presents categories of web sites. FIG. 1 is an example of the categories in one embodiment of the system. Referring to FIG. 1, the system presents categories Social Media 101, Media 102, Finance 103, Web/News 104, Shopping 105, and Connect 106, In one embodiment of the system, a Share button 107 is always available to enable the rapid sharing of web sites and content to one or more social media sites or other locations. The user does not need to send data one at a time for each desired communication method (e.g. facebook, twitter, and the like) but can select one or more of the options and share to all selections simultaneously.

The categories are selected to represent tasks and activities that are typically accessed by a user when using the internet. However, it should be noted that these categories may be changed as desired by the user. In addition, the system may be implemented with a fixed number of categories or with a customizable number of categories, either more or less. The category presentation may be size adjusted to allow more categories to appear, the categories may be sorted into multiple rows, the categories may be scrollable to allow some to be shown and some to be hidden, the categories may be nested within category designations, or the categories may be presented in any suitable manner.

In addition to providing categories for browsing activities, the system presents individual web sites as normalized tiles in one embodiment. When a site is visited by the user, a normalized version of the site is created for presentation to the user. A plurality of these normalized versions can be resident on a single page in the form of tiles. The user may interact with the site at the reduced size, or may cause any individual site to expand to a larger presentation. In one embodiment, the expanded presentation is the actual version of the site instead of the normalized version.

The user can expand and contract these site tiles while still being resident on a personalized user page. An advantage of the system is that the user can log into the user's resident page on any computer that is connected to the internet, so that the user always has the system available.

Located on the left hand side of the toolbar is the “Rate This/Review This” function. When the icon located on the underside of toolbar is clicked, the “Rate This/Review” drop-down window is expanded. This menu gives the user the ability to Rate and Review the site they are currently on. The first option inside of the “Rate This/Review This” is to give the site a one thru five star rating. These star icons can be clicked and when the star is full in color indicates the rating in which a consumer has given the site. Beneath the “Star Rating” is a text box window where a consumer can write a review or give comments about the site they are on. By clicking the button to the right of the of the “Text Box” window the user submits their review. Inside of the “Text Box” is a scroll bar located on the far right on the “Text Window”.

The bottom half of the “Rate This/Review This” drop-down window is a listing of other “Star Ratings” and “Reviews” that others have given the current URL. The “Star Rating” given by a user is shown about the “Text Box”. The “Text Window” contains the review that the user has written. In the right-hand side of the “Text Box” is a scroll bar that allows a user to scroll through the written review. Below the “Text Box” are two buttons. The button located to the furthest right is an “Agree” or “Like” button wherein a user can indicate that they agree or like the rating that particular user has given. Below and to the far left-hand side of the “Agree or Like” button a “Text Box” which allows a user to contribute, rebuke or agree to the above user comment. To the right-hand side of the “Text Box” is a “Submit” button which allows the consumer to submit their most recent comment input into the “Text Box”.

On the upper left of the toolbar is a graphic box containing a numerical value between the numbers of one and five. This value indicates the average “Star Rating” that consumers have given the current URL. This number is the aggregate average of the reviews of the URL given. Each URL that user navigates will have this number and dynamically changes depending on the aggregate average of the “Star Rating” reviews for the site.

All of the data within the “Rate This/Review This” feature is used in creating an “Opinion Leader Score” which allows to see who are the most influential users on the internet. By monitoring the actions of other users after reading a particular review, commenting on it or rebuking it we are able to determine who is influencing the buying, navigating, and user habit actions online.

The “Rate This/Review This” data is processed based on metrics related to time spending reading a review, commenting on it, comments contributed to comments, length of comment chain, next actions, future actions, “Likes” or “Agrees” to a comment, review or star rating.

Located on the right-hand side of the toolbar is the “Offer of the Day” drop-down function. The “Offer of the Day” is a coupon offer function. When a user clicks on the “Offer of the Day” button the “Offer of the Day” drop-down window appears. Located in the center of the drop-down window is a “Graphic Box” where offers will appear in graphic and text format. On the bottom left-hand side of the “Graphic Box” is a “Buy Button”. The user can purchase the coupon right from this “Buy Button” which is populated with payment methods available in the “Finance” section of the menu system. When the consumer clicks on the “Buy Button” to purchase an available coupon the available payment methods will appear for the user to choose from. To the right hand side of the “Buy Button” is a “No Button” which allows the consumer to decline the offer and be served another coupon.

All of the profile data contained within the browser database is aggregated to create special unique offers for each individual browser user. Coupon offers are served based on navigation habits, time spent on particular sites or looking at particular subject matter as well as geographic targeting available through unique I.P. addresses and mobile devices.

Retailers, restaurants and service providers can serve coupons based on real-time geographic information. I.E. if a consumer is travelling coupons can be served based on the current location of the individual.

Social Media 101

The purpose of this category is to provide the user of the system with access to all of the user's social media accounts in one place. The user is able to upload photos, videos and links from one place as well as update statuses, comment on other statuses, control notifications and accept/deny friend requests across multiple platforms. The user can control their social media life using this drop down with no need to visit individual social media sites. An example of the sites that could be auto-populated into this section include Facebook, Myspace, Bebo, Twitter, Match.com, E-Harmony.com, Free Spirit Singles, Linkden, Google+, My Yearbook, Vyclone, and the like.

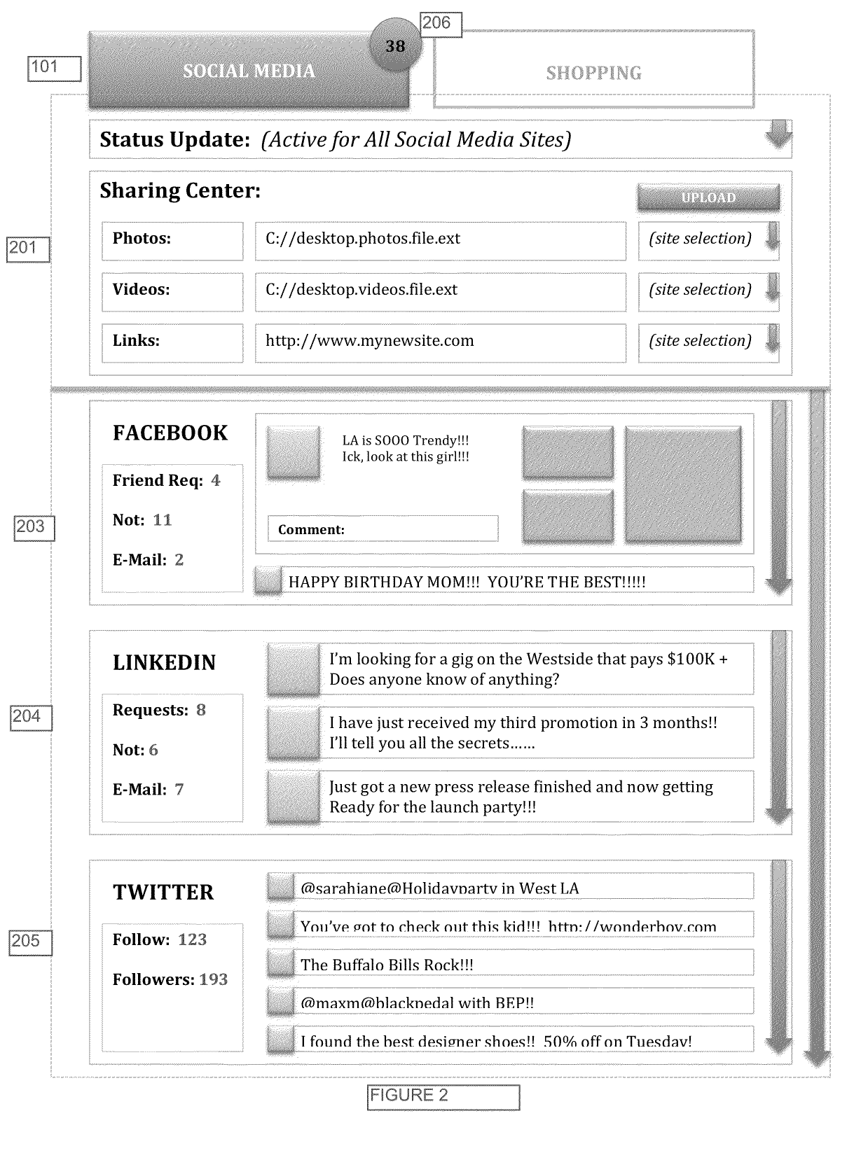

FIG. 2 illustrates the presentation of the Social Media category 101 in a drop down embodiment. The circular icon 206 at the upper right corner of the Social Media category 101 is used to indicate activity on one or more of the social media accounts associated with the user. This activity may be shown by some combination of color, animation, and/or numerical indicator. In one embodiment it is a bright red icon that shows on the category titles across the toolbar even when the toolbar windows are not expanded. In one embodiment, this icon 206 will have a number inside of it (such as the number 38 in red circle of the Social Media 101) that indicates the number of “new” pieces of information contained within the expanded toolbar. For Social Media these may include, but are not limited to: Friend Requests, Notifications, E-Mails, New Followers, New Pictures, and the like.

In one embodiment, the system provides a social media status update window 201. The status update window 201 is an active status update window for all social media sites that are populated in the system toolbar. This allows a user to update all their social media sites from one status update input.

On the right hand side of the status update window, there may be an auto-populated drop down menu that offers the user the ability to pick the social media sites to which they want the status update to be posted. This menu allows the user to be able to pick a single site for positing or to select multiple sites all at the same time.

When active, the social media category shows the user's social media accounts in separate normalized presentations. In the example of FIG. 2, these include Facebook 203, LinkIn 204, and Twitter 205. The list of accounts includes a scroll bar bar within each normalized presentation to allow the user to scroll through a plurality of messages and communications. In addition, a scroll bar is provided to scroll to additional accounts that are not shown in the initial view.

Media 102

The purpose of this “category is to collect media sites and content that are relevant to the user. The system allows data to be shared among web sites selected by the user. This may be by allowing access to accounts established by the user at various sites. As an example, if a system user access the content presentation site “Hulu”, the activity of the user on other sites may be linked to the Hulu account to aid in finding relevant content. For example, if the user visits websites like the “Wall-Street Journal”, the data will be accessible to Hulu and Hulu can then feed shows that are business related to the Hulu user. In this “Drop-Down” feeder window the user should also be able to add shows/movies/music to their queues as well as immediately buy items such as shows/movies/musics/apps with “one-click” purchasing. This media “Drop-Down” should be able to feed media content to the user they might have not otherwise known about or even knew existed. Also, within this media “Drop-Down” feeder window the user should be able to use music-serving services like “Pandora” or “Spotify”. The type of sites that would be populated into this “Drop-Down” feeder window include, but are not limited to: Media Serving Sites, Hulu, TV.com, network sites, Pandora, Spotify, Napster, Limewire, Netflix, iTunes, and the like.

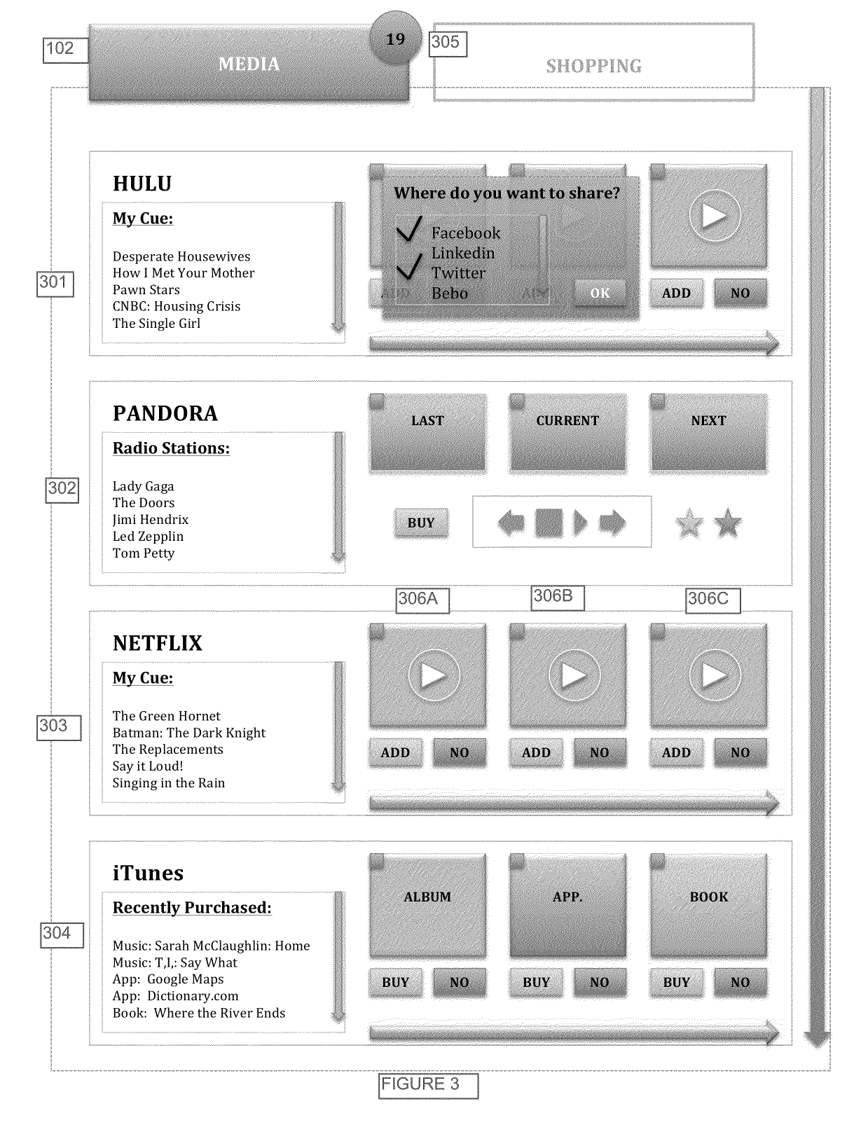

An example of an embodiment of the activated Media 102 category is illustrated in FIG. 3. The alert icon 305 may have a number inside of it (e.g. 19) that indicates the number of “new” pieces of information contained within the expanded toolbar. For the Media “Drop-Down” these would include, but not limited to: New television episodes, New movies, New music for purchase, New mobile applications for purchase, New e-books for purchase, and the like.

The system of FIG. 3 also includes “Individual Media Feeder Windows” specific to one media service. For example, FIG. 3 illustrates Hulu 301, Pandora 302, Netflix 303, and iTunes 304. When a system user logs-into any media serving website, their username and password are stored in a system “keychain”. From this point forward the system user is automatically logged into all of their accounts and content fed directly to them that is specific to their individual user habits.

At the bottom of each “Individual Media Feeder Window” is a Left to Right Scroll bar that scrolls through all of the media that is populated into the “Individual Media Feeder Window”.

Individual Media Windows. Each media window (which is represented with the grey colored box icon, such as windows 306A-306C), will be an active “Thumbnail” window with the populated television program or movie, or other content. When the consumer clicks the “Play” button in the center of the window the content will begin to play. If the consumer desires to navigate to the actual page on a content provider where the television show/movie is, they simply “click” the thumbnail again and will be taken directly to the link where the content is from. Also, when the system user rolls the mouse over one of the “Individual Media Windows”, there will be an expanded “window” that is populated with relevant information about the media.

In the upper left corner of individual sites is the name of the site, which allows the user to directly navigate to the actual site instead of using the normalized window of the system.

Each normalized window includes and “Add” icon. This icon, when clicked, will add the respective content to the system users “queue” associated with the user account. The system also includes a “No Button” that offers the system user the ability to decline content that is being served. When this button is clicked, the fed content will disappear and be replaced by the content to the right-hand side of it. From there new content will be fed into the line from the media site.

A “My Queue Scrolling Window” is the window that is on the left-hand side of the “Individual Media Window”. This is where the system user can see all of the content that they have added to their queue from that media site.

All of the titles of the shows that are populated into the system users' “My Queue Scrolling Window” and are “clickable” links. When the user clicks on any of the titles in their “My Queue Scrolling Window”, the browser will navigate to the provider page where the show is stored and automatically start playing. When the user has watched the episode or movie that is populated into this cue, the title will be removed from the “My Queue Scrolling Window”.

Pandora 302. When a system user logs into Pandora for the first time, their Pandora account will be populated into system toolbar. Because the system “Keychain” stores both the username and password, the system user will always be logged into Pandora. The Pandora window will allow the system user to have access to system without having to have an individual browser window open with Pandora.

Individual Media Windows. These are the grey icons that are in the Pandora Feeder Window. Just like when a consumer is logged into their Pandora account these grey icons represent the albums that are being played. When the user of the system toolbar rolls the mouse over one of the “Media Windows” they will get an expanded window that contains the content information:

The Pandora Icon/Log is a “Clickable” link that takes the user of the system straight to the homepage for the users Pandora account. The normalized site tile of the system includes a scrollable list of content (in Pandora terminology, “Radio Stations”) that is retrieved from user account information. The user is able to accomplish the majority, if not all, of the operations that a user can do at the Pandora site, using the normalized presentation. Such operations include station selection, content purchasing, pause, volume, skip, re-ordering, text and title display, time, content purchase, and the like. Similarly, the normalized presentations of the Netflix 303 and iTunes 304 sites include most, if not all, of the functionality of the original site.

The “Universal Share Button” is the icon (e.g. blue icon) that is located in the upper-left hand corner of each “Album/Song Titles” window. When the user clicks on this button, an expandable window appears that is populated with all of the system users social media account and has a selection window next to the title of each that the user can select and share the song across one or multiple social media sites.

Finance 103

The system provides a method of managing a user's financial accounts at a single location that is browser accessible from any computer. In one embodiment the system provides a dual layer of password protection to improve security for the user. The user identifies all accounts that the user wishes the system to manage. Data from these accounts can be consolidated and presented to the user in a number of customizable formats so that the user can more efficiently manage a plurality of accounts.

In one embodiment, the system provides a single browser location that includes access to all of the user's financial accounts and data without the need to navigate from site to site. In one embodiment, the system automatically logs into each account site when the user access the browser location. However, in one embodiment, the user must enter an additional password to access the accounts, thereby reducing the opportunity for others to accidently access the financial data.

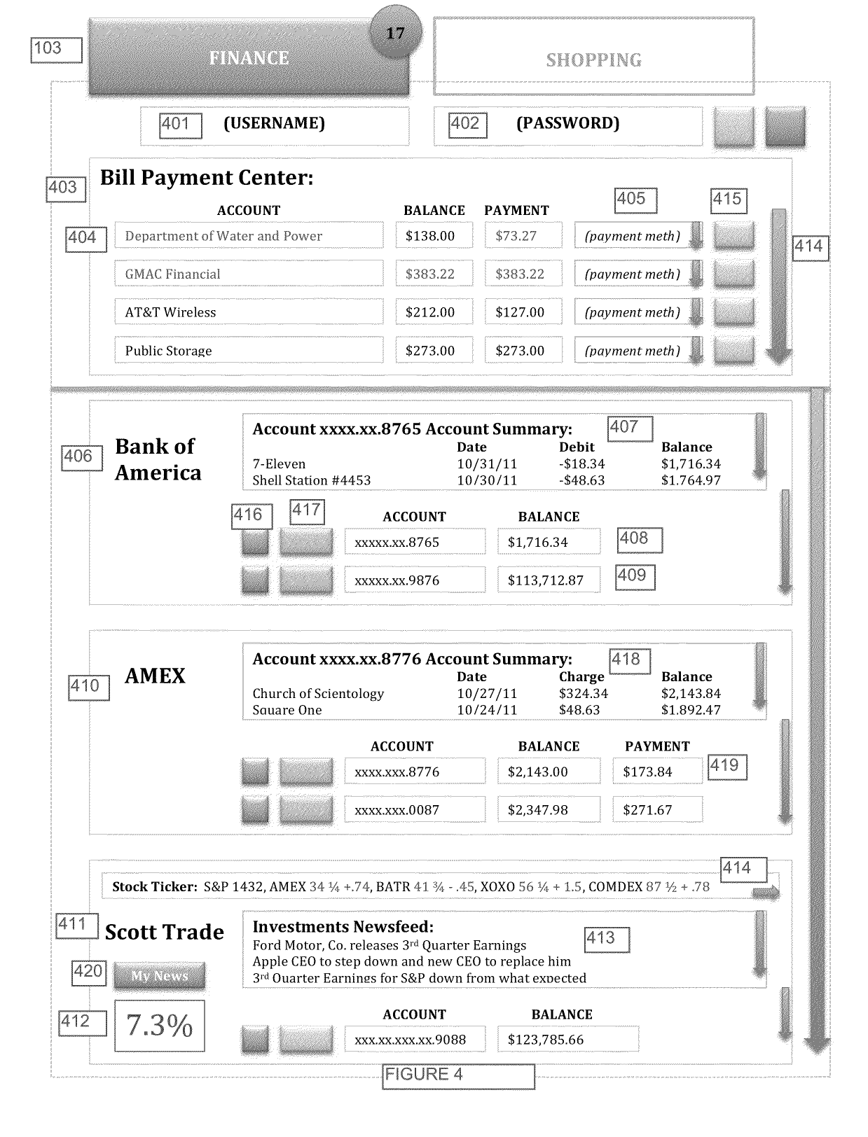

FIG. 4 is an example of the presentation of a plurality of financial accounts at a single browser location in one embodiment of the system. The system includes a login region for Username 401 and Password 402. In one embodiment, this is a second level password that provides the ability of the user to access this integrated interface. There is a time limit for how long the user is logged into the “Finance” section of system, meaning that this section of the toolbar is deactivated after, for example, 15 minutes.

Each financial account may have their own Username and Password requirement. When a system user logs-into any of their accounts, the username and password of each account are stored in a system “Keychain” and their financial information is then populated in the system. In the background the system logs into each user account and scrapes the appropriate data that will be displayed in the system templates. The user receives updates from all integrated accounts as well as having access to payments of bills and balance inquiries. The types of accounts that are in this section of system toolbar include credit cards, debit cards, savings accounts, checking accounts, retirement accounts, stock accounts, loans, mortgages, and the like. The user can also associate all bills that can be paid online with the system. Whatever data the user is entitled to view and access for any of the accounts is available to the integrated system as well.

In one embodiment, the system may include a red notification icon with a number inside of it that indicates the number of “new” pieces of information associated with the integrated finance system.

The system includes a Bill Payment Center 403 where current and prior bills are accessible by the user. The System may be configured to sort the bills by due date, amount, or in any other manner desired by the user. The system provides its own consistent interface for the bills, regardless of the source of the data. The system can scrape the data from the providing source in the same manner that the user would be permitted. In the normalized view of FIG. 4, the system presents the Account 404, the Balance, Payment (user may opt to show minimum payment), and Payment Method 405. The Payment can also be adjusted by the system user by simply deleting the current number in the window and re-entering the new payment amount they would like to make. The Payment Method 405 allows the user to select from one of a plurality of payment sources for paying an outstanding bill.

In one embodiment, the user can select preferences that will change the color of the name of the account to indicate the temporal status of the bill. For example, the account name might appear in red if the bill is overdue. Some other color may indicate that the bill is due within a certain number of days (e.g. 5 days).

On the right-hand side of the Bill Payment Center 403 is a scrolling bar 414 that allows the user to scroll through all the bills that are populated into the Bill Payment Center 103.

The user of the system can use the Payment Method 405 to select from which account to make the payment. An example of this would be that a consumer has the ability to choose to use their Visa, AMEX, Discover or Mastercard as well as be able to choose to use a checking account or savings account for payment.

The Payment Confirmation Button 415 is a button (e.g. a green button) that is located to the right of the Payment Method Drop-Down Window 405. When the user has selected the payment method for the bill they want to pay, the Payment Confirmation Button 415 will “highlight/glow” to indicate that the bill can then be paid. From this point all the user has to do is “click” the button and the payment from the selected account will be processed. This system allows the user to easily go through the outstanding bills and make payments as desired from various user accounts.

An advantage of the system integration is that the account displays that are available to the user will be automatically updated with each payment. If the user is paying bills from a checking or savings account, for example, the system will automatically debit the account with each bill payment, obviating the need for the user to constantly go back and forth to check balances to make sure there are sufficient funds to transact business. In one embodiment, if a proposed payment were to result in an overdraft of funds, the system can prohibit the transaction or warn the user to confirm that the overdraft is authorized. When available, the system may also display an overdraft fee total adjacent the account balance so that the user can better track all costs associated with overdrawing of an account.

Individual accounts can be displayed as well. In the system, regardless of where the account is sourced, the system can normalize certain data from the account so that the user has a consistent interface with which to interact with the account. One example of an account interface is the Bank of America account display 406. The system includes an account summary box 107 that includes a partial account number (e.g. with only the last four or five numbers showing as well as recent account activity. This will include activity accomplished through the system as well as extra-system activity as long as it is available on the user's account. The system is periodically polling the account data source to pull information for use in the system. If the system encounters a requirement to log-in to the source account for any reason, the system uses the keychain to reestablish communication with the source account.

In the example 406, the user has two different accounts 408 and 409 showing in the display (more can be available using the scroll bar). The user can see the individual account numbers and balances. Again, the balances are updated based on system and extra-system use. Note that when the account is updated based on system use, the system confirms the transaction when the source account is updated to ensure accuracy. Any deviations are noted to the user.

In one embodiment, the name and/or the “Financial Institution Logo” is on the far left-hand side of the account window and is the name and logo of the represented financial institution. The logo itself is a “clickable” button that when clicked will take the user of the system bar straight to the user's actual account page. Because the system “Keychain” has the username and password stored, the user will be taken right to the main account page as if they had logged in themselves at the actual site.

The icon 416 that is next to the account line 408 is a “clickable” button that when clicked will populate the Scrolling Account Summary Window 407 with the account summary for the account to which it corresponds. When a particular account is selected by this button the button will have a “glow” that indicates the account is selected.

The rectangle 417 is where the account icon will go. An example of this would be the logo of the type of credit card (i.e. American Express Gold, Target Visa, etc.). This logo is a “clickable” button that the user can “click” and be taken directly to the corresponding webpage where there the full account information is available.

An example of a credit card display is Amex 410. A credit card window will include an account summary 418 that shows recent activity. It will also include account numbers and balance on each account (e.g. if there are two or more cards associated with the account) as well as the payment 419 due on each card.

An Individual Finance Account window 411 is illustrated for a Scottrade account. A Stock Ticker Window 414 is shown that includes stocks owned by the user and/or stocks selected by the user to “watch”.

The window 411 includes a performance display 412 that shows the net gain or loss of the user's investments from the previous day as a percentage of assets. This display can be changed to absolute dollars if desired. The system user can set the preference on this to calculate the daily, weekly, monthly, quarterly or annual increase or decrease in their portfolio. If there is an increase in the account balance, the window and text will be green and if the account balance is down, the window and text will be red. Window 411 also includes an account balance display.

This window also includes a Scrolling Newsfeed Window 413. The news that is populated in this window is based on the investments that the system user is invested in. The articles that are populated into this window are auto-populated. Each one of the articles is “clickable” and the user can click on any of the news titles and be directed to the content hosting provider. There is a scroll-bar on the right-hand side of the feeder window that allows the user to scroll through all of the articles that are being fed into the “investment newsfeed”. The user can use an “alert” type interface so that the news feed will provide stories that have certain combinations of terms as defined by the user.

The My News Button 120 toggles the information that is contained in the “Scrolling Newsfeed Window”. What this means is that when the user clicks on the “My News” Button all the relevant news, based on the investment portfolio of the user, will populate into this window.

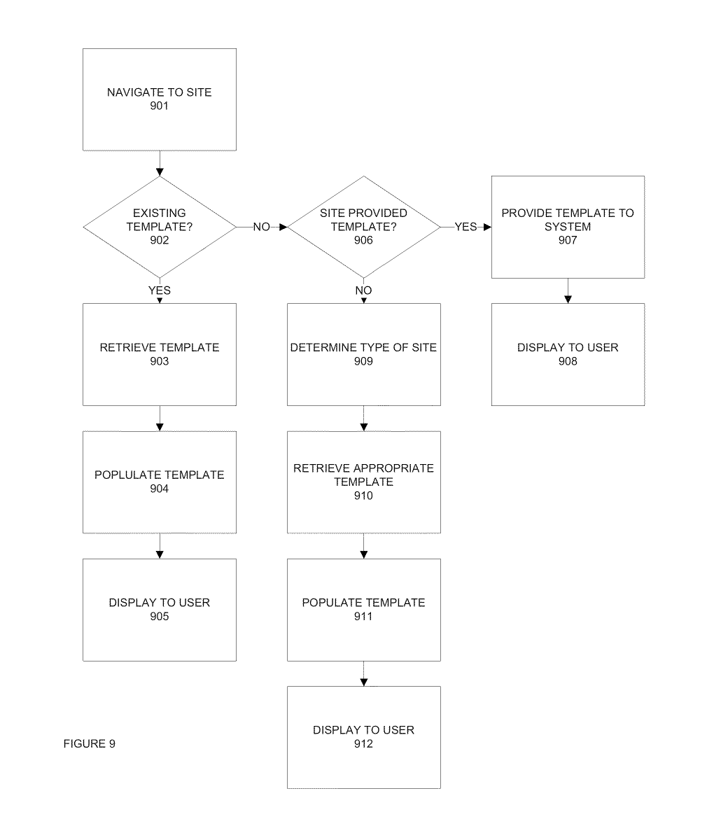

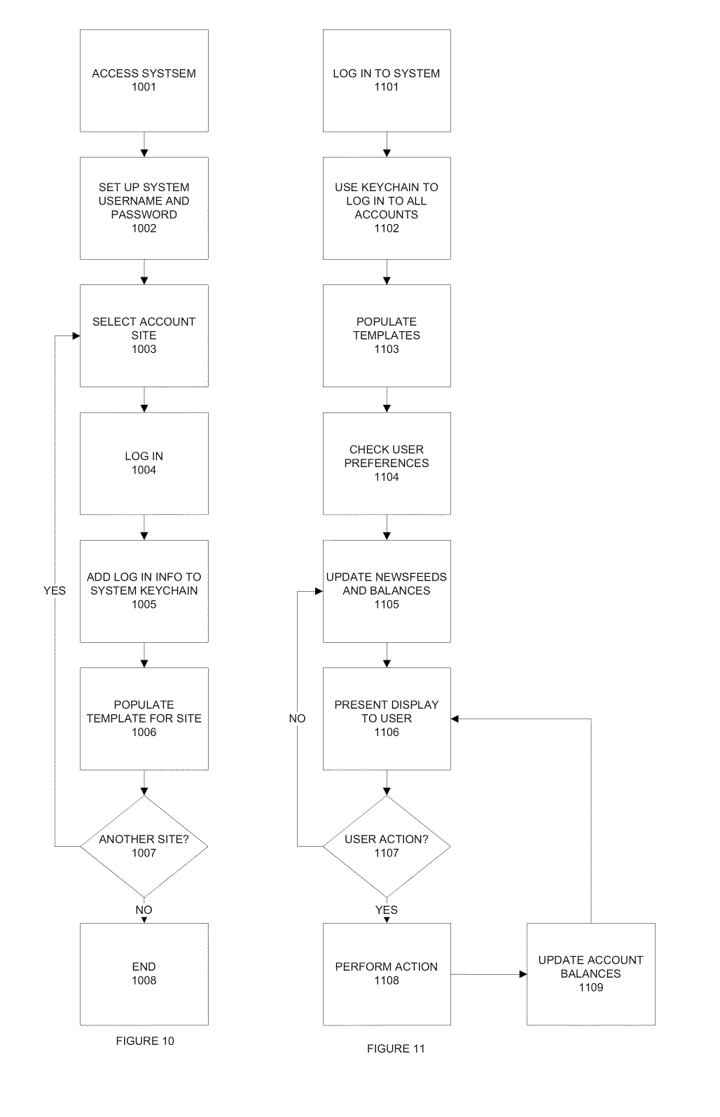

FIG. 10 is a flow diagram illustrating the operation of an embodiment of the system. At step 1001 the user initially accesses the system. At step 1002 the system prompts the user to set up a username and password for the system. This is the second level login requirement of the system.

At step 1003 the user selects one of his financial account sites. This could be an investment account, credit card, utility, bank account, and the like. At step 1004 the user logs in to the account. At step 1005 the system adds this log in information to the system keychain so that the system can automatically log in for the user and keep access open whenever the user is in the system.

At step 1006 the system selects the appropriate normalized template for the type of site involved and populates the template with data from the site. At decision block 1007 it is determined if the user wishes to add another site. If so, the system returns to step 1003. If not, the system ends at step 1008.

FIG. 11 is a flow diagram illustrating the operation of the system in typical use. At step 1101 the user logs in to the system using the system level password. At step 1102 the system uses the keychain to log in to all of the user's financial accounts that have been associated with, and integrated into, the system. At step 1103 the system populates the individual account templates with data pulled from the account sources.

At step 1104 the system checks the user preferences to determine what parameters to use for displaying accounts and other information to the user. At step 1105 the system updates the newsfeeds and balances and at step 1106 the data (via the templates) is displayed to the user.

At decision block 1107 it is determined if the user has taken any actions. Such actions could be fund transfer, bill paying, stock sale or purchase, and the like. If not, the system returns to step 1105 and updates the balances and newsfeeds for display to the user.

If the user has taken an action at decision block 1107, the system performs the action at step 1108. Based on the action, the system updates the account balances at step 1109 and returns to step 1106. Step 1108 is performed at a system level rather than waiting for the account sources to update, as that may take a longer time than the substantially real time update of the system.

Web/News 104

The Web/News 104 “Drop-Down” feeder window is used for news related or sites that have regularly updated content that the system user frequents. The information that is feed to the user in this “Drop-Down” feeder window is relevant to the users preferences based on data tracking. The information that users can get from this “Drop-Down” feeder window in one embodiment are broken up into categories such as, but not limited to: World News, Local News, Politics, Fashion, Entertainment, Sports, Business, Blogs, Automotive, Real Estate, Legal, and the like.

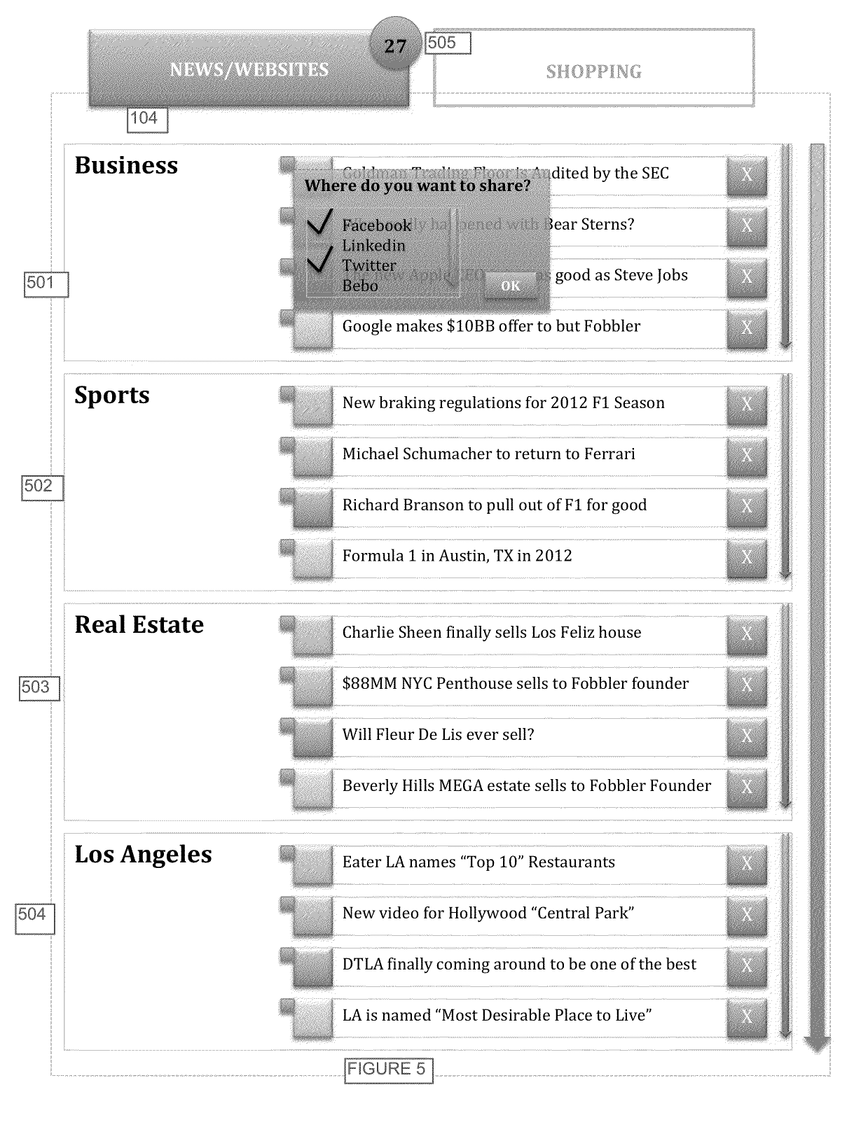

FIG. 5 illustrates an example of the Web.News category 104. The Web/News category 104 also includes a circle alert icon 505 that may indicate using color, animation, and/or a numeric indicator (e.g. 27) the presence of new articles and feeds of interest.

Every time that a consumer goes to a website the data is tracked and relevant content is populated into this “Drop-Down” Feeder menu. Each segregated section is created for the individual user depending on the surfing habits of the consumer. As an example if a user spends time looking at sports 502, one of the feeders would be dedicated to sports. The more and more that the consumer uses the system, the more and more specific the content can get to the individual user. If someone spent most of their time looking at a particular football team, the system would be able to establish this viewing habit and populate content relevant to that particular preference. The names of each of the segregated “feeder windows” will depend on the individual user. Other feeders illustrated in FIG. 5 include Business 501, Real Estate 503, and Los Angeles 504. These feeders will vary by user and by activity of the user.

Scrolling Feeder Window. Each one of the segregated “Scrolling Feeder Windows” has populated content that is relevant to the category title. There is a scroll bar on the right-hand side of the window that allows the user to scroll through all of the feeds that are populated into the “Scrolling Feeder Window”. Within the “Scrolling Feeder Window” are the following items:

The logo of the content provider is indicated by the icon located on the left-hand side of each news feed. This icon should be a “clickable” button that when “clicked” the browser will load the front-page of the content providing site.

To the right-hand side of the “Content Provider Logo” is a text box that has the summary title of the relevant article. This text box should be a “clickable” button that links the system user straight to the article or content. This is different than the content provider logo on the left, whereas it links to the article rather than the homepage.

An “X” Box is located on the far right-hand side of the text box and allows the consumer remove articles that are not of interest from the “Scolling Feeder Window”. When the user of system clicks on this the article will disappear and the next article below will move up in the window.

Shopping 105

The purpose of this “Drop-Down” feeder window is that the user of the system toolbar will feed shopping offers that are relevant to them based upon all of their web-browsing habits. This area of the system toolbar puts the entire internet shopping experience right in front of the system user for instantaneous use and accessibility. The offers that are populated into this “Drop-Down Feeder Window” are all tailored to the individual system user. As an example of the power of this “Drop Down Window” if the system user has watched a TV show on Hulu.com about golf, the information will be shared with Amazon and Amazon will be able to feed offers related to golf to the system user. The types of sites that are populated into this “Drop Down Feeder” window are sites that have purchasable products listed for internet users to buy. A sampling of sites that would be populated here include Amazon, E-Bay, Craigslist, Overstock, manufacturers sites, aggregator sites, reatailers, and the like.

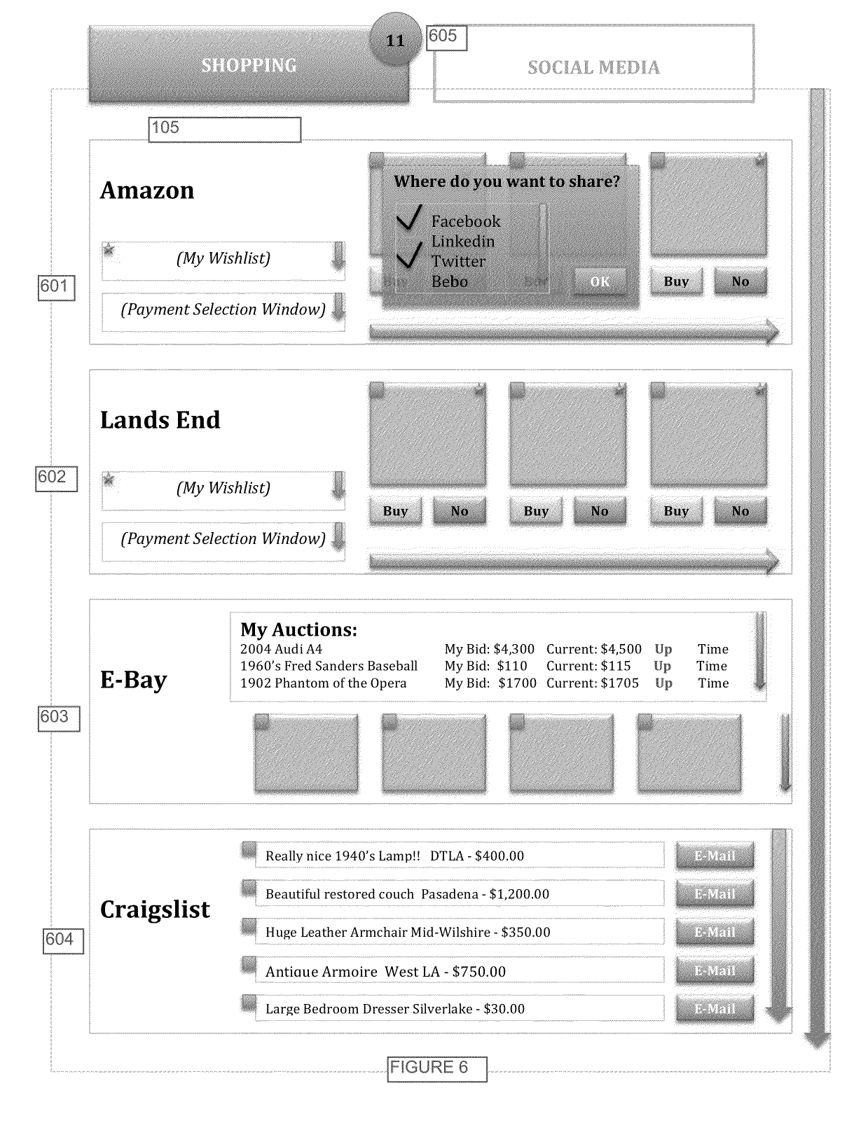

FIG. 6 is an embodiment of an activated Shopping category 105. The alert icon 605 may have a number inside of it that indicates the number of “new” pieces of information contained within the expanded toolbar (e.g. the number 11 in the example).

The system “Sharing Button” is available on every news feeder link so users can share anything that is on their toolbar. The way that this works, is when a user “clicks” on the “Sharing Button” a pop-up over-lay menu comes up and presents a list of the Social Media sites that they are users of The user interface of pop-up over-lay is similar to the Apple scrolling window that looks like the wheel on a slot machine. Next to the name of each social media account the user can click and select for a social media account they'd like to share the link with.

Each “Individual Shopping Feeder Window” is specific to one shopping service. When a system user logs-into any shopping serving website, their username and password are stored in the system “keychain”. From this point forward the system user is fed automatically logged into all of their accounts and content fed directly to them that is specific to their individual user habits. The example shows Amazon 601, Lands End 602, E-Bay 603, and Craigslist 604.

At the bottom of each “Individual Shopping Feeder Window” is a Left to Right Scroll bar that scrolls through all of the shopping offers that are populated into the “Individual Shopping Feeder Window”.

The Amazon “Shopping Feeder Window” 601 is an example of one of the “Shopping Feeder Windows” that is dedicated to a specific e-retailer. The first time that the system user logs into their Amazon account, their Amazon data will be stored in the system “Keychain”. This would include their username and password and also their payment information that is contained on the Amazon site. The Amazon “Shopping Feeder Window” would also appear in the system drop-down window without their Amazon log-in information. This “Shopping Feeder Window” would also store information in their system “Keychain” that is relevant to their purchases. The information that would be contained in this would be things like: Sizes, Colors, Patterns, Shipping Address, Billing Address, and the like.

The “My Wishlist Drop-Down” window is the window that is located to left of the “Shopping Feeder Window”. This is a drop-down window that expands to list the items that the system user has added to their wishlist. Inside the “My Wishlist Drop-Down” window will be a text list of all of items that the system user has added to the list and to the right hand side of each text item will be a red “delete” button in which the system user can delete items from their wishlist.

When the system user rolls their mouse icon over an item, offer, or icon, there will be a “Roll-Over Expansion Window” that expands over the thumbnail photo of the offer itself. Inside of this “Roll-Over Expansion Window” is information such as: Manufacturer, Price, Ratings (If Available), Discount, and the like.

The “One-Click Buy Button” is located on the bottom left-hand side of each of the “Offer Window”. The “One-Click Buy Button” is unique in the “Shopping Drop-Down Feeder Window” whereas it allows the system user to buy items that are being fed in the “Offer Windows” straight from the system toolbar. When the system user sees an offer that they are interested in, they simply click on the “One-Click Buy Button” to purchase the item. When the system user clicks on the “One-Click Buy Button” the “Payment Selection Window” will highlight indicating for the system user to select the payment method they want to use to complete the purchase.

The “Payment Selection Window” is located to the left-hand side of the “Shopping Feeder Window” and is located directly underneath the “My Wishlist Window”. The “Payment Selection Window” is a drop-down menu that is populated with all of the available payment methods that the system user has populated into their “Finance Feeder Drop-Down Menu”. As an example, if the system user has a Wells Fargo Visa, Bank of America Visa and an AMEX available, these accounts will present themselves in the “Payment Selection Window”. The consumer can then scroll through all of the available accounts and select the account they want to use to complete the purchase.

The above purchase chain can most likely be refined and make it easier for the system user. In one embodiment the consumer clicks on the “One-Click Buy Button” and there is an expanded over-lay window that shows all of the available accounts, rather than the “Payment Selection Window” highlighting.

If there are options for the system user in the purchase of the product, such as color, size, etc. they will show in this “Expanded One-Click Buy Button Overlay Window”. This will be dependent on the e-tailer/retailer and the products/options that are being purchased.

The “No” button is located to the right-hand side of the “One-Click Buy Button”. When the consumer clicks on this button, the offer is removed from the scrolling offer window and the offer to the right-hand side will take the place of the declined offer. The newest offer will be populated at the end of the line of the offers.

The Land's End “Shopping Feeder Window” is an example of one of the “Shopping Feeder Windows” that is dedicated to a specific e-tailer. The first time that the system user logs into their Land's End account, their Land's End data will be stored in the system “Keychain”. This would include their username and password and also their payment information that is contained on the Amazon site. The Land's End “Shopping Feeder Window” would also appear in the system drop-down window without their Amazon log-in information. This “Shopping Feeder Window” would also store information in their system “Keychain” that is relevant to their purchases.

E-Bay 603. The E-Bay “Shopping Feeder Window” is an example of one of the “Shopping Feeder Windows” that is dedicated to a specific e-tailer. The first time that the system user logs into their E-Bay account, their E-Bay data will be stored in the system “Keychain”. This would include their username and password and also their payment information that is contained on the E-Bay site. The E-Bay “Shopping Feeder Window” would also appear in the system drop-down window without their E-Bay log-in information. This “Shopping Feeder Window” would also store information in their system “Keychain” that is relevant to their purchases.

The Craigslist “Shopping Feeder Window” 604 is an example of one of the “Shopping Feeder Windows” that is dedicated to a specific e-tailer. Although Craigslist doesn't technically sell anything from their site it would still be populated into the “Shopping Feeder Window”. The system algorithm watches everything that the system user is doing and is able to see the types of listings that the user is looking at on Craigslist. Take for example, if the user is frequently looking at antiques, the offers that will be predominantly populated into the “Craigslist Shopping Feeder Window” will be antiques that fit into the category that the user frequents; this is accomplished by the system algorithm basically “reading” the content that is on Craigslist and pulling relevant data particles for the system user. This area of the system toolbar really shows the dynamic capabilities of the algorithm. Let's say that the system user looks mainly at antiques and then all of a sudden starts looking at apartments in West Los Angeles that are 2 Bd./2 Ba. And in the range of $2,000-$2,200/mnth. The system algorithm will dynamically change with the user and start pulling apartments from Craigslist that fit into this category. When the system user stops looking for apartments (after they have found one) the algorithm will populate new data particles based on the users new movements.

Craigslist Icon. This is the icon that is located on the far left-hand side of the “Shopping Feeder Window”. When the system user clicks on this icon, the users browser will navigate straight to the Craigslist homepage.

Text Item Listings. These are the text boxes that are located inside of the Craigslist “Shopping Feeder Window”. Each of the “Text Item Listings” are “Clickable” links that when the system user clicks on them their browser will navigate to the posting that is Craigslist.

When the consumer rolls over a listing a “Text Item Expansion Window” will expand and overlay the Craigslist “Shopping Feeder Window” with a preview of the listing that is on Craigslist. This way, the user can see a preview of the listing and determine as to whether or not they want to navigate to the listing itself.

Connect 106

The Connect category 106 (also known as Communication Center) is intended to collect all of the user's communications accounts in one location, including email, gmail, hotmail, instant messaging, and the like. The Connect 106 also includes a red alert indicator 704 to represent the presence and number of new messages of the user.

FIG. 7 illustrates an example of the system when the Connect category 106 is activated. The system shows various communication accounts of the user such as Instant Messaging 701, Hotmail 702, and Gmail 703. Each of the accounts is normalized to a consistent presentation that may be different from the native presentation of the account. This permits an easier and more consistent interface for the user. At any time, the user can activate the native site of any account and have that site present on the user's display.

Sharing 107

Sharing Button. The system “Sharing Button” is available as a category and, in one embodiment, is available on every link so users can share anything that is on their toolbar. The way that this works, is when a user “clicks” on the “Sharing Button” a pop-up over-lay menu comes up and presents a list of the Social Media sites that they are users of Next to the name of each social media account the user can click and select for a social media account they'd like to share the link with.

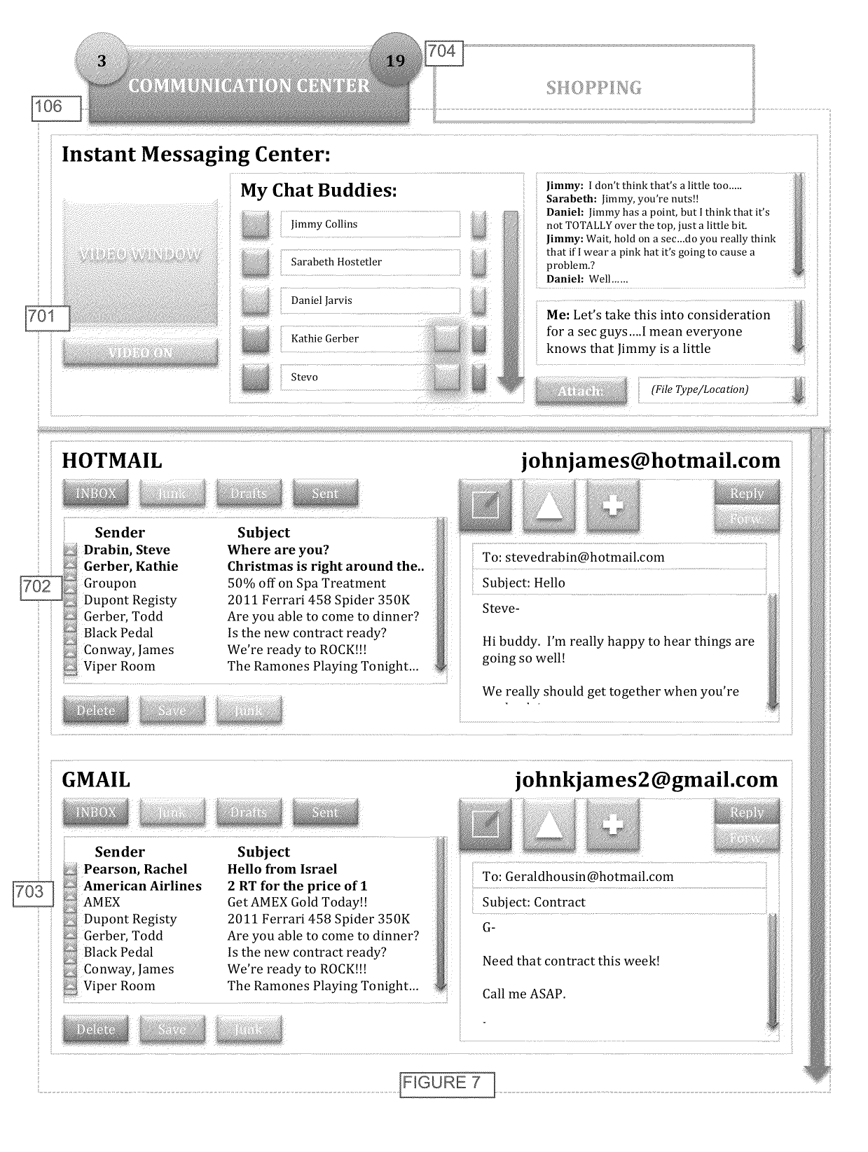

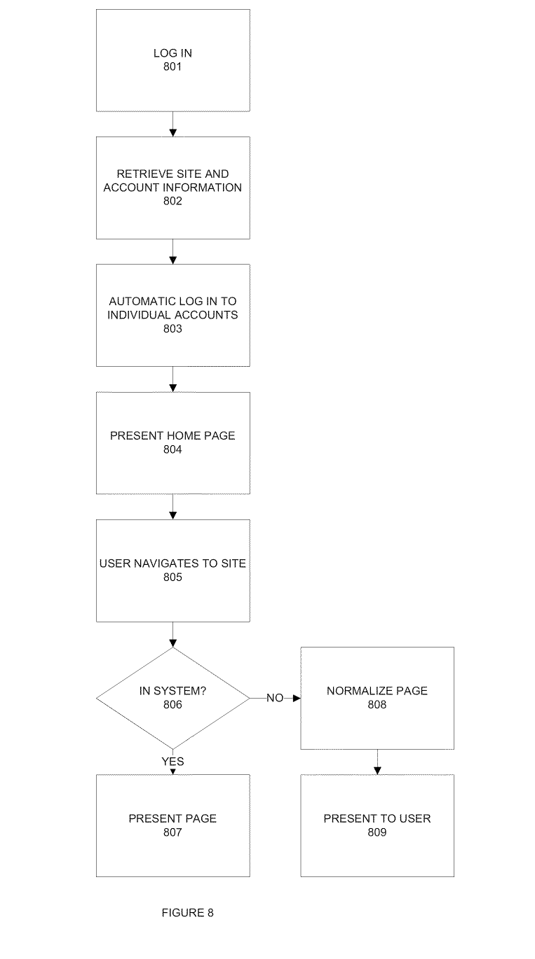

FIG. 8 is a flow diagram illustrating the operation of the system in an embodiment. At step 801 the user logs in. At step 802 the system retrieves all site and account information that the user has already entered. At 803 the system automatically logs in to any password and username initiated account as appropriate and as authorized by the user.

At step 804 the system presents the home page to the user with appropriate alerts indicated in each category. At step 805 the user navigates to a web page. At decision block 806 it is determined if the page is already part of the user's system. If so, the system presents the normalized view of the page and updates statistics about the users preferences accordingly at step 807.

If it is a new page, the system prepares a normalized version of the page at step 808 and presents it to the user at step 809.

Normalized Presentation

As noted above, one of the advantages of the system is the ability to normalize websites to a consistent presentation in the system. This allows for greater ease of use for a system user because actions and data are in consistent and expected locations in each template. The normalized templates also provide the most relevant information in a smaller presentation package so that more data is available to the user in a typical home screen. The normalized data presentation allows the user to access multiple web sites and actions without ever really leaving the home page of the user. The user is always free to go directly to the original of a normalized site if desired.

FIG. 9 is a flow diagram of the creation of a normalized presentation of a new website in an embodiment of the system. At step 901 the user navigates to a website. At decision block 902 it is determined if there is already a template for a normalized version of the website resident in the system. If so, the system retrieves the template at step 903 and populates the template at step 904. At step 905 the system presents the populated template to the user.

If there is no existing template for a normalized version of the website at decision block 902, the system checks at decision block 906 to determine if the website has a system style normalized template available for use. The system contemplates that websites will be willing to create templates following a developers API provided by the system. When a user navigates to the website, the site provides the already prepared template to the system. If the site has a template available at decision block 906, the template is provided at step 907 and the template is displayed to the user at step 908.

If there is no site provided template at decision block 906, the system must provide one. At step 909 the system determines the type of site that has been presented. For example, the site may be a communication site, shopping site, social media site or some other site that can be placed within one of the categories of the system. At step 910 the system retrieves a template appropriate for the site type. At step 911 the system populates the fields of the template as appropriate and displays the normalized site to the user at step 912.

User Customization/Integrated Browser

The system provides a method of managing a user's profile and browser experience using real time and historical data from the user as well as sharing information with other sources.

When a user initiates the system, a resident page is created with a tool bar that presents categories of web sites. Referring again to FIG. 1, selecting any one of the categories causes the region 108 to be populated with a plurality of normalized templates of websites associated with that category. The present system provides a method and apparatus for ranking the sites associated with any category so that the presentation of sites is in an order that is most useful to the user and reflects the actions and derived desires of the user.

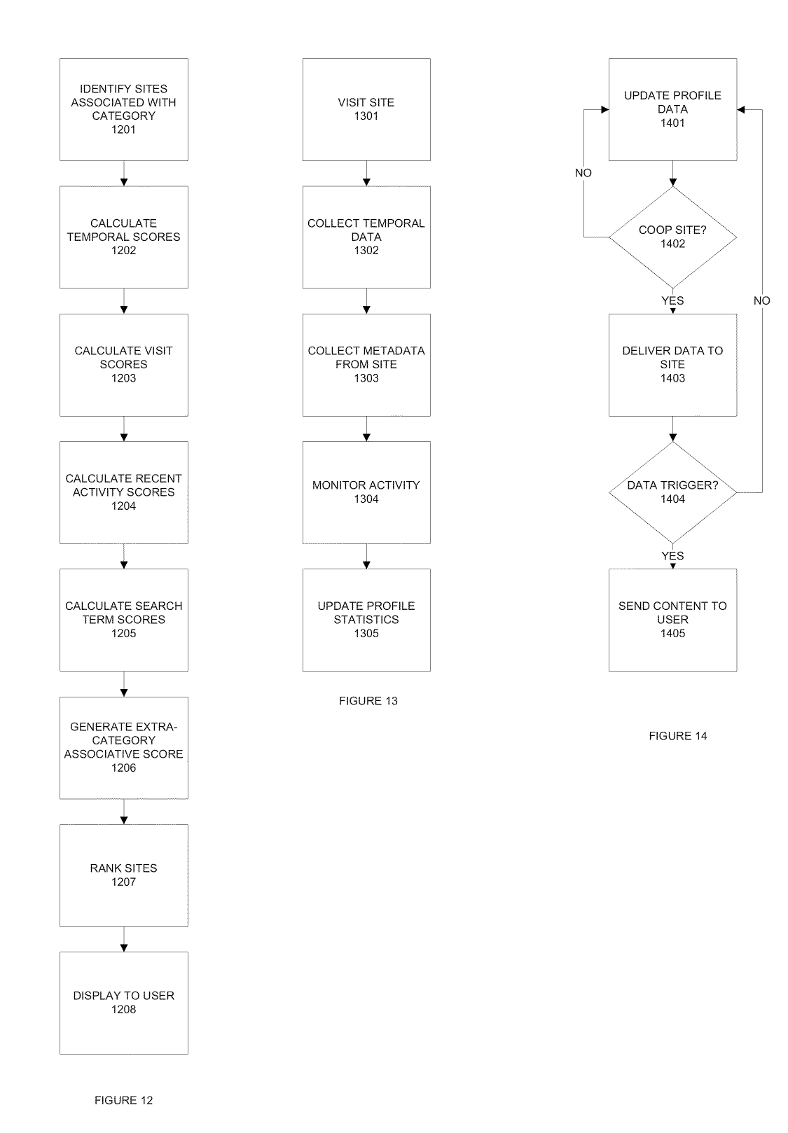

FIG. 12 is a flow diagram illustrating an embodiment of site ranking determination of the system. In one embodiment, the system assigns scores or weight to a plurality of factors to determine the order in which sites should be presented. At step 1201 the system identifies the sites associated with the category. These are any sites that the user has visited in the past and that are associated with a particular category.

At step 1202 the system calculates scores for the sites based on temporal data. For example, the system may identify if certain sites are always visited on certain days of the week, days of the month, or days of the year. The system may also identify if sites are visited at certain times of day. For example, a user may use email in the morning and not use other social media communication sites until lunch time or after work. Therefore, on a weekday morning, an email site will have a higher score than a twitter site for example.

At step 1203 the system calculates visit scores. This may be a simple aggregate count of number of visits to each site in the category. In another embodiment it may be a more statistical analysis based on recent activity (over a number of days or weeks for example) and assigns a visit score to each site.

At step 1204 the system checks for recent activity (e.g. most recent one or more times the category was accessed and what sites were accessed within the category) and calculates a recent activity score.

At step 1205 the system calculates a site score based on search terms that the user has used over some time period. For example, if the user was searching for travel related information, the system may assign a higher score to sites related to travel than to other sites.

At step 1206 the system generates an associative score for each site based on extra-category activity of the user. This includes searches, site visits, transactions, uploading or downloading activity, and the like from other categories and assigns a score for sites in the present category based on those activities.

Finally, at step 1207 the system ranks the sites based on the generated scores and presents the sites to the user in order at step 1208.

As the user continues to visit and interact with different sites within a category, the system continues to collect data about the sites and actions taken, and collects metadata and statistical data to be used in modifying the preference profile of the user.

In other embodiments, the user may set preferences for certain sites to always appear in the first one or more places if desired, with non-preferred sites being ranked according to the system.

Profile Building

The system uses all information from user browsing activity to build, supplement, and dynamically modify a user profile. In one embodiment of the system, the user profile has two parts. One part of the profile is used to manage site presentation and another part is used to enhance and customize passive content retrieval for presentation to the user. Data collected includes all activities of the user such as sites visited, time spent per site, metadata associated with each site, category of each site, search terms, purchases, articles read, reservations made, ratings and rankings employed by the user (where available), items forwarded via social media and communication methods.

The profile is updated dynamically and continuously based on actual actions of the user. The different parts of the profile may be configured to change more rapidly or slowly depending on the particular activity. For example, search terms show a short term interest of the user in certain items or activities. Therefore those terms will have a greater short term impact on profile settings. Other activities may require a longer time frame to determine profile preferences. For example, high visit counts to a particular website over a long time period would not be eclipsed by recent visiting activity. Consider a user who frequently visits one or more sports sites. The user profile will reflect this user as a sports fan. One or two visits to a theater site or classical music site will not immediately change the trend profile for this user.

FIG. 13 is a flow diagram illustrating data collection for profile management using the system. At step 1301 the user visits a site. At step 1302 the system collects all temporal data associated with the site visit, including time of day, day of week, date, and the like. At step 1303 the system collects all metadata available from the site. This helps in assigning an appropriate category to the site as well as managing the user profile. At step 1304 the system monitors all activity at the site, including search terms, actions taken, purchase made, content selected, sharing decisions, and the like.

At step 1305 the system updates the user profile statistics. In one embodiment, each site has an associated histogram that includes number of hits of any term or metadata.

Data Mining/Data Sharing/Ad delivery

In one embodiment, the system includes a cooperative relationship with other sites to allow better provision of content and more targeted advertising. The system allows other web sites to identify data of interest from a user and to then generate content (and/or ads) to return or serve to the user.

FIG. 14 is a flow diagram illustrating the sharing of data in an embodiment of the system. At step 1401 the user profile is updated. This may be the result of activity, purchases, search terms, communications, uploads, downloads, and the like. At decision block 402 it is determined if any third party site has a cooperative agreement with the system for that particular kind of profile data (it may be the case that a third party site is not interested in all user data but only certain kinds or types of data).

If there are one or more sites that have a cooperative agreement with the system for the update data at decision block 402, the system proceeds to step 1403 and shares the data with the each cooperative site. If there are none, the system returns to step 1401.

After the site receives the data at step 1403, the site determines if the data is a trigger for providing information to the user at decision block 404. If the data is a trigger for some content to be delivered to the user, the system sends the content to the user at step 1405. This content could be an ad related to searches or activity of the user. For example, if the user is searching for travel to England, the third party site could provide airfare, hotel, and restaurant offers related to travel to England to the user.

The data mining is not limited to ads or even to third party sites. Third party sites and/or the system itself can provide customized news feeds to the user based on profile data changes. This improves the user experience because the user is automatically provided content and information of interest to the user, both long term interests and short term interests.

Another advantage of the system is the ability to provide a specific type of user to third party sites. Instead of attempting to define a demographic that hopes to include parameters of interest to a third party site, the system will allow a third party site to specifically lay out a plurality of parameters of interest and have specific users returned that match those parameters. Such focused content and ad delivery results in higher click-through rates and is correspondingly more valuable to third parties than existing schemes such as Ad-Sense.

Embodiment of Computer Execution Environment (Hardware)

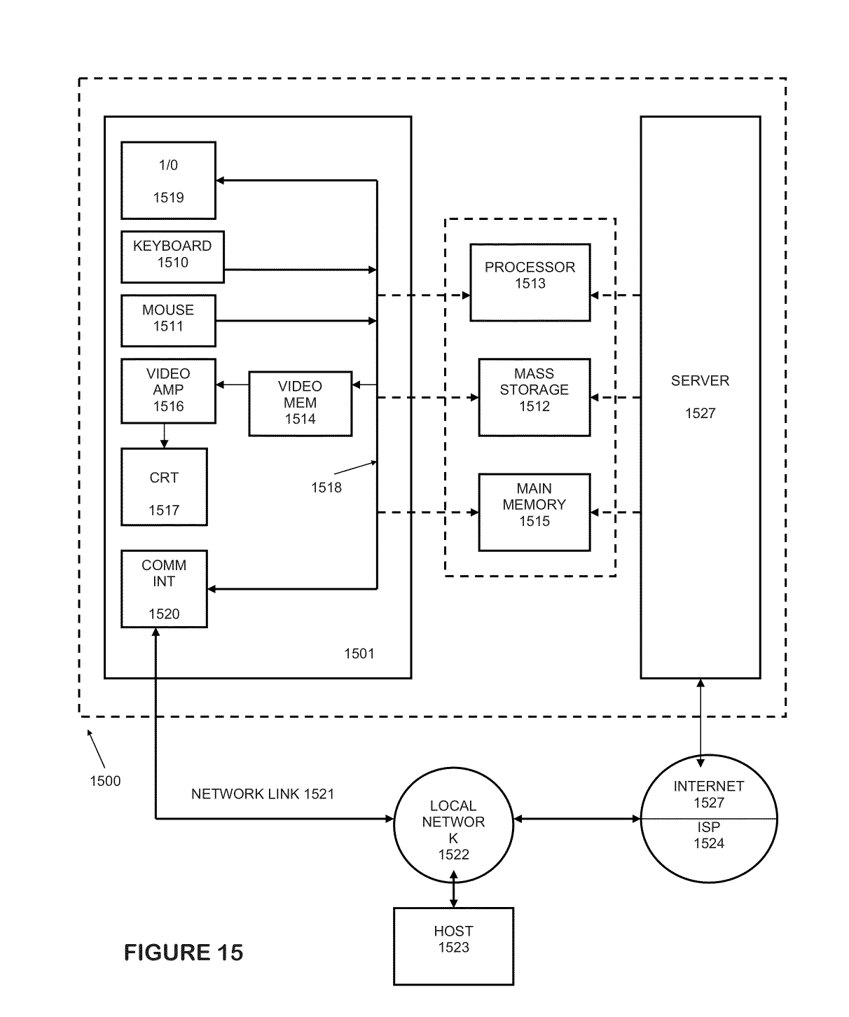

An embodiment of the system can be implemented as computer software in the form of computer readable program code executed in a general purpose computing environment such as environment 1500 illustrated in FIG. 15, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1510 and mouse 1511 are coupled to a system bus 1518. The keyboard and mouse are for introducing user input to the computer system and communicating that user input to central processing unit (CPU 1513. Other suitable input devices may be used in addition to, or in place of, the mouse 1511 and keyboard 1510. I/O (input/output) unit 1519 coupled to bi-directional system bus 1518 represents such I/O elements as a printer, A/V (audio/video) I/O, etc.

Computer 1501 may be a laptop, desktop, tablet, smart-phone, or other processing device and may include a communication interface 1520 coupled to bus 1518. Communication interface 1520 provides a two-way data communication coupling via a network link 1521 to a local network 1522. For example, if communication interface 1520 is an integrated services digital network (ISDN) card or a modem, communication interface 1520 provides a data communication connection to the corresponding type of telephone line, which comprises part of network link 1521. If communication interface 1520 is a local area network (LAN) card, communication interface 1520 provides a data communication connection via network link 1521 to a compatible LAN. Wireless links are also possible. In any such implementation, communication interface 1520 sends and receives electrical, electromagnetic or optical signals which carry digital data streams representing various types of information.

Network link 1521 typically provides data communication through one or more networks to other data devices. For example, network link 1521 may provide a connection through local network 1522 to local server computer 1523 or to data equipment operated by ISP 1524. ISP 1524 in turn provides data communication services through the world wide packet data communication network now commonly referred to as the “Internet” 1527 Local network 1522 and Internet 1527 both use electrical, electromagnetic or optical signals which carry digital data streams. The signals through the various networks and the signals on network link 1521 and through communication interface 1520, which carry the digital data to and from computer 1500, are exemplary forms of carrier waves transporting the information.

Processor 1513 may reside wholly on client computer 1501 or wholly on server 1527 or processor 1513 may have its computational power distributed between computer 1501 and server 1527. Server 1527 symbolically is represented in FIG. 15 as one unit, but server 1527 can also be distributed between multiple “tiers”. In one embodiment, server 1527 comprises a middle and back tier where application logic executes in the middle tier and persistent data is obtained in the back tier. In the case where processor 1513 resides wholly on server 1527, the results of the computations performed by processor 1513 are transmitted to computer 1501 via Internet 1527, Internet Service Provider (ISP) 1524, local network 1522 and communication interface 1520. In this way, computer 1501 is able to display the results of the computation to a user in the form of output.

Computer 1501 includes a video memory 1514, main memory 1515 and mass storage 1512, all coupled to bi-directional system bus 1518 along with keyboard 1510, mouse 1511 and processor 1513.

As with processor 1513, in various computing environments, main memory 1515 and mass storage 1512, can reside wholly on server 1527 or computer 1501, or they may be distributed between the two. Examples of systems where processor 1513, main memory 1515, and mass storage 1512 are distributed between computer 1501 and server 1527 include thin-client computing architectures and other personal digital assistants, Internet ready cellular phones and other Internet computing devices, and in platform independent computing environments,

The mass storage 1512 may include both fixed and removable media, such as magnetic, optical or magnetic optical storage systems or any other available mass storage technology. The mass storage may be implemented as a RAID array or any other suitable storage means. Bus 1518 may contain, for example, thirty-two address lines for addressing video memory 1514 or main memory 1515. The system bus 1518 also includes, for example, a 32-bit data bus for transferring data between and among the components, such as processor 1513, main memory 1515, video memory 1514 and mass storage 1512. Alternatively, multiplex data/address lines may be used instead of separate data and address lines.

In one embodiment of the invention, the processor 1513 is a microprocessor such as manufactured by Intel, AMD, Sun, etc. However, any other suitable microprocessor or microcomputer may be utilized, including a cloud computing solution. Main memory 1515 is comprised of dynamic random access memory (DRAM). Video memory 1514 is a dual-ported video random access memory. One port of the video memory 1514 is coupled to video amplifier 1519. The video amplifier 1519 is used to drive the cathode ray tube (CRT) raster monitor 1517. Video amplifier 1519 is well known in the art and may be implemented by any suitable apparatus. This circuitry converts pixel data stored in video memory 1514 to a raster signal suitable for use by monitor 1517. Monitor 1517 is a type of monitor suitable for displaying graphic images.

Computer 1501 can send messages and receive data, including program code, through the network(s), network link 1521, and communication interface 1520. In the Internet example, remote server computer 1527 might transmit a requested code for an application program through Internet 1527, ISP 1524, local network 1522 and communication interface 1520. The received code maybe executed by processor 1513 as it is received, and/or stored in mass storage 1512, or other non-volatile storage for later execution. The storage may be local or cloud storage. In this manner, computer 1500 may obtain application code in the form of a carrier wave. Alternatively, remote server computer 1527 may execute applications using processor 1513, and utilize mass storage 1512, and/or video memory 1515. The results of the execution at server 1527 are then transmitted through Internet 1527, ISP 1524, local network 1522 and communication interface 1520. In this example, computer 1501 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

In one embodiment, the system is implemented via cloud computing. Because it resides in the network cloud, it is always on, allowing instant access to the system on log in and allowing all password connected sites to be always connected as well without risking unwanted access by others.

What is claimed is:

1. A method for presenting a web site to a user comprising:
Using a computing system,
Navigating to the web site;
Determining if the system has a template for the web site;
Populating the template with data from the web site when the system has a template for the web site;
Displaying the populated template to the user.

2. The method of claim 1 further comprising;
Determining if the web site has provided a template when the system does not have a template;
Using the web site template when the web site has a template;
Populating the template with data from the web site Displaying the populated template to the user.

3. The method of claim 2 further comprising:
Determining the type of web site when the system and the web site do not have a template;
Retrieving a template associated with that type of web site;
Populating the template with data from the web site;
Displaying the populated template to the user.

4. The method of claim 3 further comprising displaying a plurality of templates on a home page, each template being a normalized version of a web site.

5. The method of claim 4 further comprising maintaining a link between each template and the web site and updating data in the template from the web site.

6. A method for aggregating financial accounts of a user in a browser comprising:
In a computing system,
Creating a keychain in a home page, the keychain comprising the log-in name and password for each of a plurality of financial account web sites;
Creating a secondary username/password combination to access the keychain;
Automatically accessing information from each financial account using the keychain when the secondary combination has been entered;
Presenting the information from each account to the user at a home page.

7. The method of claim 6 wherein each financial account is presented in a template.

8. The method of claim 7 wherein each template is a normalized version of a web site associated with a financial account.

9. The method of claim 8 wherein the keychain is updated when a new financial account is added.

10. The method of claim 9 wherein each template is continuously updated from the associated web site.

11. A method of presenting browser information to a user comprising;
In a computing system,
Identifying a plurality of sites associated with the user;
Calculating a plurality of scores associated with the plurality of web sites;
Presenting the web sites to the user based on the plurality of scores.

12. The method of claim 11 wherein the plurality of scores comprise temporal scores, visit scores, activity scores, search term scores, and associative scores.

13. The method of claim 12 further including maintaining a user profile with score data and updating the score data based on browsing activity.

14. The method of claim 13 further including providing user profile data to a cooperating site and receiving user specific content from the cooperating site.

15. The method of claim 14 further wherein the user specific content is a deal offer.
